(19) United States
(12) Patent Application Publication
(10) Pub. No.: US 2025/0096822 A1
(43) Pub. Date: Mar. 20, 2025

(54) SYSTEMS AND METHODS OF A COMBINED WIRELESS SYSTEM

(71) Applicant: Meta Platforms Technologies, LLC, Menlo Park, CA (US)

(72) Inventors: Qiuming Li, Palo Alto, CA (US); Hongyu Zhou, San Francisco, CA (US); Bo Zhang, San Jose, CA (US)

(73) Assignee: Meta Platforms Technologies, LLC, Menlo Park, CA (US)

(21) Appl. No.: 18/630,692

(22) Filed: Apr. 9, 2024

Related U.S. Application Data
(60) Provisional application No. 63/539,397, filed on Sep. 20, 2023.

(51) Int. Cl. H04B 1/00; H04B 1/40

(52) U.S. Cl. CPC H04B 1/006; H04B 1/40

(57) ABSTRACT

Disclosed herein are systems and method for using a cellular communication chain integrated with RFID wireless communication to communicate with an external RFID tag and a cellular wireless base station. A front end circuit can receive a first RF signal as input and can provide, as output, a processed first RF signal for wireless communication via a cellular network and be a low-band signal. An RFID circuit can generate a second RF signal for wireless communication with an RF identifier tag. A switch circuit or one or more toggle switches can be configured to route the processed first RF signal for transmission via an antenna for the wireless communication via the cellular network and route the second RF signal for transmission via the antenna for the wireless communication with the RF identifier tag.

### CROSS-REFERENCE TO RELATED APPLICATIONS

This application claims the benefit of and priority to U.S. Provisional Application No. 63/539,397 filed Sep. 20, 2023, the contents of which are incorporated herein by reference in its entirety.

### FIELD OF DISCLOSURE

The present disclosure is generally related to wireless communication between devices, including but not limited to, systems and methods for combining radio frequency identification (RFID) and cellular radio frequency (RF) system and antenna.

### BACKGROUND

Augmented reality (AR), virtual reality (VR), and mixed reality (MR) are becoming more prevalent, which such technology being supported across a wider variety of platforms and device. Some AR/VR/MR devices may communicate with other devices within an environment via various RFID, WLAN or cellular connections or links.

### SUMMARY

The technical solutions described herein can integrate cellular communication and RFID circuitry to enable combined wireless communication in user equipment (UE). To provide cellular wireless communication via UE devices, UE devices can utilize designated cellular communication (e.g., transmit/receive) chains of circuitry that is configured for cellular wireless communication. Likewise, when providing RFID functionality, the UE devices can utilize a separate circuitry chain configured for the RFID communication. It can be desirable to benefit from the fact that some of the RFID applications operate in the shared frequency range as some of the cellular wireless communications such that using separate circuitries is not energy efficient and consumes additional hardware resources. The technical solutions overcome these challenges by integrating a portion of a cellular communication chain circuitry with a portion of a circuitry for RFID communication to provide a combined cellular and RFID wireless communication chain to facilitate both cellular wireless communications and RFID communications over the shared hardware.

An aspect of the technical solutions is directed to a wireless communication device. A front end circuit can be configured to receive, from a transceiver, a first radio frequency (RF) signal as input and can provide a processed first RF signal as output. The processed first RF signal can be for wireless communication via a cellular network and can satisfy a threshold for low-band frequencies. An RF identifier circuit can be configured to generate a second RF signal, wherein the second RF signal is for wireless communication with an RF identifier tag and can satisfy the threshold for low-band frequencies. A switch circuit can be configured to route the processed first RF signal for transmission via an antenna for the wireless communication via the cellular network, and can route the second RF signal for transmission via the antenna for the wireless communication with the RF identifier tag.

The wireless communication device can include an amplifier of the transceiver configured for wireless communication via one or more cellular networks, the amplifier configured to output the first RF signal. The front end circuit can be comprised in a cellular communication chain. The front end circuit can include a power amplifier to process the first RF signal and output an amplified first RF signal, and a filter switch circuit to receive the amplified first RF signal as input and output the processed first RF signal.

The wireless communication device can include the filter switch circuit of the front end circuit that includes at least one of: a filter to suppress one or more frequencies of the amplified first RF signal, a duplexer circuit configured to reduce an interference between the processed first RF signal to be transmitted via the antenna and a third RF signal received via the antenna, or a switch to route the processed first RF signal to the switch circuit.

The wireless communication device can include a plurality of ports of the switch circuit. The plurality of ports can include a first one or more ports to route at least one of the first processed RF signal or the second RF signal. The plurality of ports can include a second one or more ports of the plurality of ports of the switch circuit to route one or more RF signals that do not satisfy the threshold for low-band frequencies.

The wireless communication device can include a coupler communicatively coupled with the switch circuit. The coupler can include a first port to receive at least one of the processed first RF signal or the second RF signal. The coupler can include a second port to route at least a portion of the at least one of the processed first RF signal or the second RF signal for transmission via the antenna. The wireless communication device can include the second port of the coupler that is configured to receive at least one of a third RF signal via the antenna or a fourth RF signal for the wireless communication with the RF identifier tag, and the first port of the coupler that is configured to transmit to the switch circuit the at least one of the third RF signal or the fourth RF signal. The coupler can include a third port of the coupler to transmit, to a feedback receiver of the transceiver, at least a second portion of the at least one of the processed first RF signal or a third RF signal received via the antenna.

The wireless communication device can include a toggle switch. The toggle switch can include an input port to receive, from a third port of the coupler, at least one of a portion of the second RF signal or a portion of a fourth RF signal for the wireless communication with the RF identifier tag. The toggle switch can include an output port configured to transmit to the RF identifier circuit at least one of the portion of the second RF signal or the portion of the fourth RF signal. The wireless communication device can include a toggle switch including an output port configured to transmit to a feedback receiver of the transceiver at least one of the portion of the first processed RF signal or the portion of the third RF signal.

The wireless communication device can include a switch of the front end circuit. The switch can include a first input to receive the first RF signal, a second input to receive the second RF signal; and an output to provide at least one of the first RF signal or the second RF signal to a power amplifier of the front end circuit. The wireless communication device can include a coupler between the RF identifier circuit and the switch circuit. The coupler can include a plurality of ports that can include a first port to receive the second RF signal from the RF identifier circuit, a second port to provide the second RF signal to the switch circuit and receive a fourth RF signal via the antenna, and a third port to transmit at least a portion of at least one of the second RF signal or the fourth RF signal to the RF identifier circuit.

An aspect of the technical solutions is directed to a method. The method can include receiving, by a front end circuit configured, from a transceiver, a first radio frequency (RF) signal as input to provide a processed first RF signal as output. The processed first RF signal can be for wireless communication via a cellular network and can satisfy a threshold for low-band frequencies. The method can include generating, by an RF identifier circuit, a second RF signal. The second RF signal can be for wireless communication with an RF identifier tag and can satisfy the threshold for low-band frequencies. The method can include routing, by a switch circuit, the processed first RF signal for transmission via an antenna for the wireless communication via the cellular network. The method can include routing, by the switch circuit, the second RF signal for transmission via the antenna for the wireless communication with the RF identifier tag.

The method can include an amplifier of the transceiver configured for wireless communication via one or more cellular networks. The amplifier can be configured to output the first RF signal. The front end circuit can be comprised in a cellular communication chain. The method can include processing, by a power amplifier, the first RF signal to output an amplified first RF signal. The method can include receiving, by a filter switch circuit, the amplified first RF signal as input to output the processed first RF signal. The filter switch circuit can include at least one of: a filter to suppress one or more frequencies of the amplified first RF signal, a duplexer circuit configured to reduce an interference between the processed first RF signal to be transmitted via the antenna and a third RF signal received via the antenna, or a switch to route the processed first RF signal to the switch circuit.

The method can include routing, by a first one or more ports of a plurality of ports of the switch circuit, at least one of the first processed RF signal or the second RF signal. The method can include routing, by a second one or more ports of the plurality of ports of the switch circuit, route one or more RF signals that do not satisfy the threshold for low-band frequencies. The method can include a coupler communicatively coupled with the switch circuit receiving, by a first port of a coupler communicatively coupled with the switch circuit, at least one of the processed first RF signal or the second RF signal. The method can include the coupler routing, by a second port of the coupler, at least a portion of the at least one of the processed first RF signal or the second RF signal for transmission via the antenna.

The method can include receiving, by the second port of the coupler, at least one of a third RF signal via the antenna or a fourth RF signal for the wireless communication with the RF identifier tag. The method can include transmitting, by the first port of the coupler, to the switch circuit, the at least one of the third RF signal or the fourth RF signal. The coupler can include a third port to transmit, to a feedback receiver of the transceiver, at least a second portion of the at least one of the processed first RF signal or a third RF signal received via the antenna.

An aspect of the technical solutions is directed to a cellular communication chain. The cellular communication chain can include a front end circuit of the cellular communication chain configured to receive, from a transceiver, a first radio frequency (RF) signal as input and provide a processed first RF signal as output. The processed first RF signal can be for wireless communication via a cellular network and can satisfy a threshold for low-band frequencies. The cellular communication chain can include a switch circuit configured to receive from an RF identifier circuit a second RF signal, wherein the second RF signal is for wireless communication with an RF identifier tag and satisfies the threshold for low-band frequencies. The cellular communication chain can include the switch circuit configured to route the processed first RF signal for transmission via an antenna for the wireless communication via the cellular network. The cellular communication chain can include the switch circuit configured to route the second RF signal for transmission via the antenna for the wireless communication with the RF identifier tag.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is an example of device (e.g., UE/terminal device) having a cellular communication chain integrated with RFID wireless communication to communicate with an external RFID tag and a base station of a cellular network.

FIG. 6 illustrates an example of a circuit having a cellular communication chain integrated with RFID wireless communication.

FIG. 7 illustrates another example of a circuit having a cellular communication chain integrated with RFID wireless communication.

FIG. 8 is a flow diagram of a method for using a cellular communication chain integrated with RFID wireless communication to communicate with an external RFID tag and a base station.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are related to systems and methods that can utilize a cellular communication chain circuitry to facilitate radio frequency identification (RFID) wireless communication. The technical solutions discussed herein can integrate cellular communication chain circuitry with ultra-high frequency radio frequency identification (UHF RFID) communication circuitry to support/enable combined cellular and UHF RFID wireless communication using a shared communication chain.

RFID communication circuitry can operate having its own front end and antenna separated from the cellular RF front end and antenna. However, since UHF RFID communications utilize 860 to 960 MHz band which overlaps with some of the cellular spectrum e.g., LTE or UMTS B5 and B8, the technical solutions provide a design for a wireless system that combines UHF RFID and cellular wireless circuitry by sharing a portion of the cellular communication chain and its antenna. The present technical solutions can include a wireless system supporting UHF RFID and cellular RF using a shared cellular front end power amplifier and any combination of filters, duplexers and switches that can be communicatively coupled with an antenna switch module for routing transmissions to and from the filter and antenna-plexer/multiplexer of the cellular antenna.

For example, the technical solutions can use one or more antennas shared for cellular and RFID communication. Connectors for the one or more shared antenna and their connectors can be provided for both cellular radio frequency (RF) and ultra-high frequency (UHF) radio frequency identification (RFID) applications. For example, filters (e.g., LPF, BPF, HPF, etc.) and antenna-plexers (e.g., diplexer, triplexer, n-plexer, extractor, etc.) can be designed to facilitate sharing of the low-band (LB) communication path for cellular RF and UHF RFID transmissions within cellular antenna circuits or paths.

The technical solutions can use one or more couplers, such as a single directional coupler (e.g., with the fourth port terminated) or a bi-directional coupler which can be included for the cellular feedback receiver. The technical solutions can include, within a cellular RF front module, an Antenna Switch Module (ASM) that can include a switch with multiple input and output ports (xPxT switch) or multiple xPxT switches with multiple In and Out ports that can be included to accommodate multiple radio bands supported by the device, such as cellular LB, MB, HB, UHB, and other non-cellular radios. An auxiliary port (TRx AUX) of the Antenna Switch Module can be included to facilitate toggling between UHF RFID radio and cellular LB radio. For RFID Tx and Rx paths, the choice between a coupler or an isolator can be provided, and RFID radio can be controlled by either an Application Processor (AP) or Microcontroller Unit (MCU) via SPI or other digital interfaces. The RF front-end module can include various components, such as power amplifiers (PA), external low-noise amplifiers (eLNA), switches, filters (duplexers, n-plexers, BPF, etc.), and other RF elements, which can either be integrated into one single module or retained as discrete RF components. The cellular transceiver and Application Processor (AP) can be integrated with or without the cellular modem, and the interfaces connecting the RF transceiver to the AP/Modem/MCU can encompass PCIe, SDIO, MiPi, UART, GPIO, IQ, and various other digital or analog interfaces.

Additional details of the present disclosure, as well as examples or design options and the benefits of the present disclosure, can be found herewith.

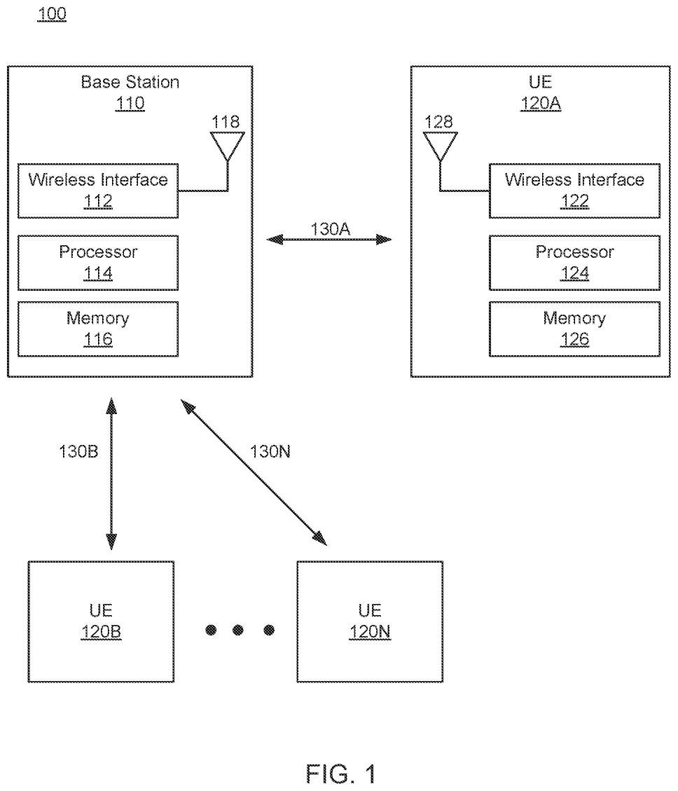

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

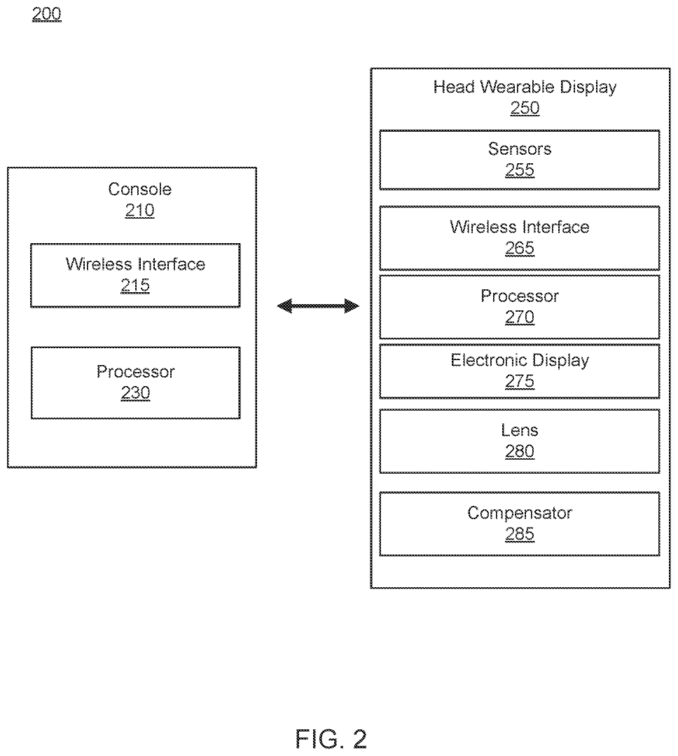

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

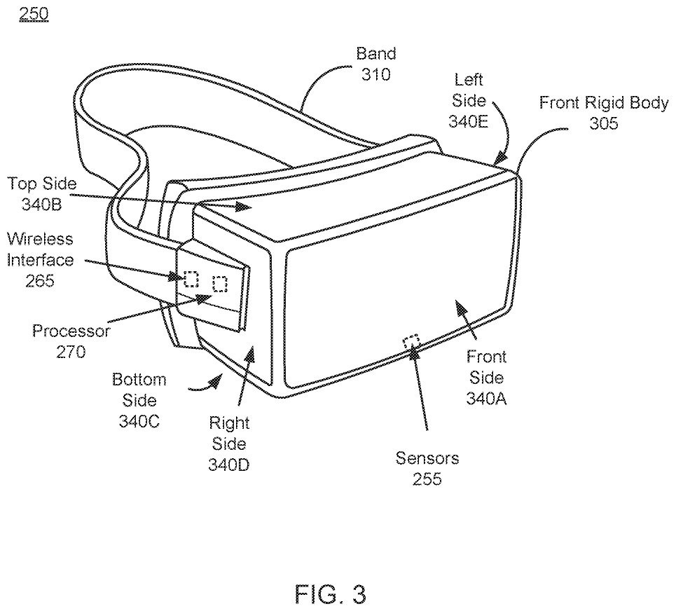

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

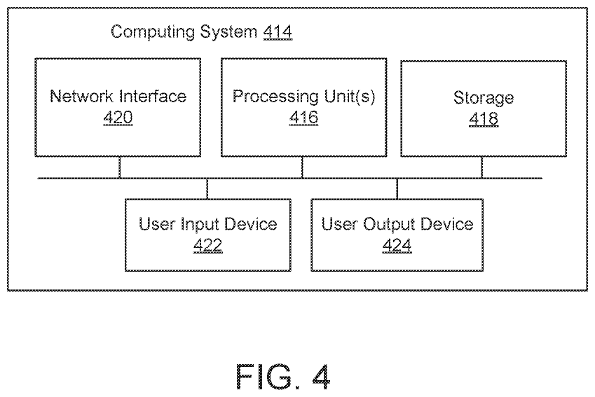

Various operations described herein can be implemented on computer systems. FIG. 4 shows a block diagram of a representative computing system 414 usable to implement the present disclosure. In some embodiments, the base station or source devices 110, the UE or sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software. Example electronic devices can include any computing devices configured for wireless communication, such as smartphones, smartwatches, tablets, laptops, IoT devices, wearable fitness trackers, industrial handheld devices, smart home devices, inventory management and asset tracking devices, retail inventory scanners, medical devices, automotive systems that utilize vehicle tracking, or any other devices that can utilize both cellular and RFID communications.

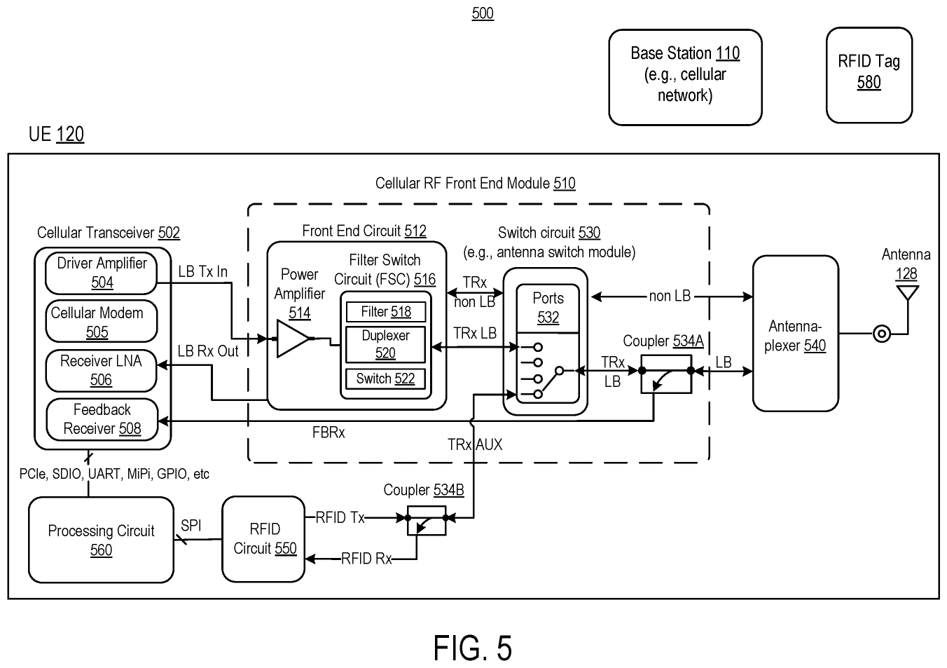

FIG. 5 illustrates an example 500 of a circuit of a user equipment (UE) device 120 having a cellular communication chain (e.g., Tx-Rx chain) integrated with RFID wireless communication functionality to communicate with an external RFID Tag 580, or a device accessory with an integrated RFID tag, and a base station 110 of a cellular network. Example 500 can include a cellular transceiver 502, a cellular RF front end module 510 that can include a front end circuit 512 and a switch circuit 530, an antenna-plexer 540 and the antenna 128, which can collectively form, or be referred to as, a cellular communication chain or a cellular RF communication chain. The technical solutions allow for at least a portion of such a cellular RF communication chain to be used for communication (e.g., transmission or receiving) of RF identifier signals generated and processed by an RFID circuit 550 sharing a portion of the cellular RF communication chain hardware.

Example system 500 can include the UE 120 having a cellular transceiver 502 that can have its low-band bidirectional communication section communicatively coupled with a front end circuit 512 of a cellular RF front end module 510. The cellular front end module 510 can include a switch circuit communicatively coupled with the front end circuit 512 to provide low-band transmission signals to an antenna 128, via an intervening antenna-plexer 540. Switch circuit 530 can be communicatively coupled with a RFID circuit 550 for managing RF identification communication, via the antenna-plexer 540 and the antenna 128. Example circuit 500 can include one or more cellular transceivers 502 having one or more driver amplifiers 504 that can operate using a cellular modem 505, a receiver low noise amplifiers (LNAs) 506 and feedback receivers 508. Low-band bidirectional communication signals can be communicated between a cellular transceiver 502 and one or more front end circuits 512. For instance, a front end circuit 512 can include a power amplifier (PA) 514 to receive a low-band transmission signal from the cellular transceiver 502 and provide an output signal that is amplified by the PA 514 as an input into a filter switch circuit (FSC) 516. The FSC 516 can include one or more filters 518, duplexers 520 and switches 522 for processing the input signal. The signal output from the FSC 516 can be provided to a switch circuit 530 that can route bidirectional low-band and non-low-band signals between the front end circuit 512 and the antenna-plexer 540 coupled with the antenna 128 for cellular communication with an external BS 110 configured for cellular network communication. One or more ports 532 of the switch circuit 530 can include a first port coupled with the antenna-plexer 540 for communication with the antenna 128, via a first coupler 534A, and a second port coupled with an RFID circuit 550, via a second coupler 534B, for bidirectional RF identification communication between the RFID circuit and an external RFID tag 580. A processing circuit 560, such as an application processor or a microcontroller, can be communicatively coupled with cellular transceiver 502 via PICe, SDIO, UART, MiPi, GPIO and/or other digital or analog interfaces and to the RFID circuit 550 via SPI and/or other digital or analog interfaces.

Cellular transceiver 502 can include any circuit or a device that both transmits and receives signals, such as low-band or non-low-band signals of a cellular communication chain to facilitate two-way cellular communication. Cellular transceiver 502 can include any combination of amplifiers, filters, mixers and oscillators that can be arranged to facilitate wireless generating signals for cellular network communication. Cellular transceiver 502 can receive and process as well as generate for transmission low-band and non-low-band signals. Cellular transceiver 502 can include or utilize filters to implement low pass filtering to provide low-band signals based on a frequency threshold. Cellular transceiver 502 can be configured to generate RF cellular signals that can be processed by the cellular RF front end module 510 for further transmission via the antenna 128 of the UE device 120 to external base stations 110 configured for cellular network communication. Cellular transceiver 502 can transmit and receive signals over specific frequency bands, and can facilitate communication of voice calls, data exchange, and other cellular services.

Driver amplifier 504 can include any electronic device used to amplify signals to a level suitable for further processing (e.g., by front end circuit 512) or for transmission. Driver amplifier 504 can include components such as amplification stages, input and output matching networks and biasing circuits. Driver amplifier 504 can include an integrated circuit or discrete component package combining various circuit components, configured to boost the strength of electrical signals while maintaining signal features and integrity. Driver amplifier 504 can be configured to amplify an input signal before the signal is processed further by cellular RF front end module 510. Driver amplifier can be coupled with, include or utilize a low pass filter to remove signal frequencies above a frequency threshold for low-band frequency range.

Cellular modem 505 can include any combination of hardware and software facilitating communication between UE and cellular network. Cellular modem 505 can include a hardware integrated circuit allowing a UE to utilize cellular communication chain and the antenna to access the internet and transmit data wirelessly via the cellular network. Cellular modem 505 can operate and process the digital domain of the cellular system and send the digital signals to the transceiver for RF domain signal transmission and receiving. Cellular modem 505 can function as an intermediary between the UE and any cellular network, such as 3G, 4G LTE, 5G or any other cellular network. Cellular modem 505 can process received cellular communication and generate cellular transmissions. Cellular modem 505 can operate via any bands or channels of the cellular network, including low-bands or channels, mid-bands or channels and high-bands or channels, each of which can be communicated over one or more antennas suitable or configured for the one or more bands or channels.

Receiver low noise amplifier (LNA) 506 can include any circuit or device designed to amplify weak incoming radio frequency signals with minimized amount of added noise. Receiver LNA 506 can include elements such as amplification stages, input matching networks, biasing circuits, and filtering components. Receiver LNA 506 can integrate these elements onto an integrated circuit or discrete component package. Receiver LNA 506 can improve the sensitivity of a receiver system, such as by improving the signal strength of the feedback signal received by the feedback receiver 508.

Feedback receiver 508 can include any circuit or a device to receiving feedback signals corresponding to the cellular network communications. Feedback receiver 508 can utilize a feedback mechanism to adjust the operation of the cellular transceiver 502 based on the feedback. Feedback receiver 508 can include one or more amplification stages, filtering circuits, feedback control loops, and signal processing units, which can be integrated into a single integrated circuit or a device. Feedback receiver 508 can monitor transmitted signals and can provide feedback to the transmitter circuitry.

Cellular RF front end module 510 can include any collection of circuits for interfacing between the cellular transceiver 502 and the antenna 128. Cellular RF front end module 510 can include any selection of circuits or components for processing, transmitting and receiving radio frequency signals. Cellular RF front end module 510 can include amplifiers, filters, switches, and matching networks, which can be integrated into one or more integrated circuits or chips. Cellular RF front end module 510 can include one or more front end circuits 512, switch circuits 530 and couplers 534.

Front end circuit 512 can include any circuitry of the cellular RF front end module 510 that interfaces with the cellular transceiver 502. Front end circuit 512 can be configured to receive and process signals between the cellular transceiver 502 and the antenna 128. Front end circuit 512 can include any combination of amplifiers, filters, switches and/or duplexers for amplifying, filtering or attenuating signal frequencies, routing or otherwise processing signals generated by cellular transceiver 502 for transmission by the antenna 128, via the switch circuit 530. Front end circuit 512 can process cellular network signals received from the antenna 128 before they are passed to the cellular transceiver 502. Front end circuit 512 can include and utilize functionalities or circuitry for creating, maintaining or facilitating the processed RF signal being a low-band signal.

Power amplifier 514 can include any circuit or a device that increases the power (e.g., amplifies) the input signals prior to their transmission via the antenna 128. Power amplifier can include circuitry, such as transistors, amplification stages or other configurations for increasing the strength of the signals before these signals are further processed by the front end circuitry (e.g., filter switch circuit 516) or prior to their transmission through the antenna. Power amplifier 514 can adjust (e.g., increase or decrease) the power of signals to adjust these signals to a power range that allows for their effective transmission via the antenna 128.

Filter switch circuit 516 can include any one or more circuits or devices for combining any one or more of filtering or routing the signals at the front end circuit 512. Filter switch circuit 516 can include any combination of a filter, a duplexer and a switch circuit to selectively filter and route signals (e.g., low-band signals processed by the power amplifier 514) in the cellular RF system. Filter switch circuit 516 can allows for the filtering and switching of signals based on frequency, direction, or other parameters.

Filter 518 can include any component that selectively allows some frequencies of a signal to pass through while attenuating other frequencies of the signal. Filter 518 can include a low pass filter (e.g., allowing passage of frequencies below a threshold frequency level), a high pass filter (e.g., allowing passage of frequencies above a threshold frequency level), or a band pass filter (e.g., allowing passage of frequencies within a particular frequency level between two frequency thresholds). Filter 518 of a front end circuit 512 can filter signals processed by the power amplifier 514 to remove unwanted frequencies and noise. Filter 518 can include or be a surface acoustic wave (SAW) filter, a bulk acoustic wave (BAW) filter, or any other type of RF filter. Filter 518 can include passive components such as capacitors and inductors, arranged or designed to attenuate specific frequency bands, ensuring that only desired signals are transmitted or received effectively.

Duplexer 520 can include any circuit or a device facilitating or allowing transmission and reception of signals on a shared antenna or a wireless chain or path. Duplexer 520 can include a front end circuit 512 that allows for simultaneous transmission and reception of signals along the same communication chain, separating incoming and outgoing signals to minimize interference. Duplexer 520 can include filters and switches and facilitate bidirectional communication while maintaining signal integrity and preventing cross-talk between transmit and receive paths. The duplexer 520 can be configured to combine the processed first RF signal of transmission and a third RF signal of receiving into a common antenna port. This combination into a common antenna port can be done while maintaining a band noise attenuation within a band noise threshold and an isolation between the transmission and a receiving signal path below an isolation threshold.

Switch 522 can include any component that controls the movement or routing of signals between different pathways or directions in a communication chain or path. Switch 522 can include the circuitry to allow signals to be directed to different components, communication chain components, or antennas as needed. Switch 522 can allow for selection of different signal paths based on specific criteria, such as control signals, frequency, direction, or signal strength. Switch 522 can include electronic components such as transistors or diodes, allowing for efficient switching between transmission and reception modes or between different RF components and paths, optimizing the performance of the communication system.

Any switch 522 or toggle switch 552 can be constructed using any combination of solid-state components such as transistors, MOSFETs (Metal-Oxide-Semiconductor Field-Effect Transistors) or any other components configured to control the flow of electrical current by either opening or closing the circuit electronically. Switch 522 can include logic gates, such as AND gates, OR gates, NOR gates, XOR gates or other gates configured to implement switching functionality in a circuit by manipulating digital signals. Switch 522 can include one or more flip-flop circuits or digital latches, which maintain their state based on input signals.

Switch circuit 530 can include any one or more circuits for selectively routing signals between different components or paths, allowing for dynamic control over signal flow between the front end circuit 512 and the antenna 128. Switch circuit 530 can include a plurality of input and output ports 532 for facilitating dynamic flow path of different signals, including transmission signals (e.g., for the antenna 128 to transmit) and received signals (e.g., received via the antenna 128). Switch circuit 530 can include control circuitry for controlling routing of signals between the RFID circuit 550 and the antenna 128, via the ports 532. Switch circuit 530 can include control circuitry for controlling routing of signals between the cellular transceiver 502 (e.g., via front end circuit 512) and the antenna 128. Switch circuit 530 can allow for selection of different signal paths based on specific criteria, such as control signals, band signals, frequency, direction, or signal strength. Switch circuit 530 can be comprised of any number of transistors, diodes, resistors, capacitors and inductors, which can be arranged into logic gates, relays, multiplexers and flip-flops to control the flow of electrical signals across different paths. Switch circuit 530 can include one or more switches 522 or toggle switches 552, along with any other circuitry configured to process or route RF signals.

Ports 532 can include any connection points on a circuit or a device (e.g., switch circuit 530) at which signals can be input or output. Ports 532 of the switch circuit 530 can provide interfaces for connecting external signals, such as signals from RFID circuit 550 and the cellular transceiver 502 (e.g., via front end circuit 512) with a coupler 534 or antenna-plexer 540 communicatively coupled with the antenna 128, and vice versa. Ports 532 of the switch circuit 530 can be configured to provide signal routing between the front end circuit 512 and a coupler 534A of the antenna-plexer 540 leading to the antenna 128. Ports 532 of the switch circuit 530 can be configured to provide signal routing between RFID circuit 550 (e.g., either directly or via an intervening coupler 534B) and a coupler 534A of the antenna-plexer 540 leading to the antenna 128. Ports 532 can operate as connection points for transmitting and receiving signals, allowing for seamless integration of the cellular RF communication chain and the RFID circuit 550.

Coupler 534, such as couplers 534A and 534B, can include any circuits or devices configured or design to pass-through, split or combine RF signals in the communication chain. Coupler 534 can include circuitry to sample signals for system monitoring or directing signal components (e.g., copies of a signal, or a portion of a signal) to another circuit or device, such as a feedback receiver 508 of the cellular transceiver. For instance, coupler 534A positioned between the switch circuit 530 and the antenna-plexer 540 can forward or transmit signals while providing a signal portion or a copy as feedback to a feedback receiver 508. For instance, coupler 534B can facilitate RF identifier signal transmission between the RFID circuit 550 and the antenna 128 (e.g., via the switch circuit 530), allowing for RF identifier communication via a portion of the cellular RF communication chain. This can be done while providing a signal portion from the antenna 128 as a receiving signal to the RFID circuit 550 receive path.

Antenna-plexer 540 can include any circuit or a device that includes or combines the functionalities of an antenna switch and a multiplexer, such as a diplexer. Antenna plexer 540 can include any functionalities of a switch 522 and any functionalities of a filter 518. Antenna-plexer 540 can allow for simultaneous transmission and reception of signals (e.g., cellular and RF identifier communication) on the same antenna while preventing interference between them. The antenna-plexer 540 can be configured to combine the processed first RF signal of transmission and a third RF signal of receiving into a common antenna port. This combination into a common antenna port can be done while maintaining a band noise attenuation within a band noise threshold and an isolation between the transmission and a receiving signal path below an isolation threshold.

RF identifier circuit 550, also referred to as an RFID circuit 550, can include any circuitry or device for generating, encoding, receiving, decoding or otherwise managing RF identification communication. RFID circuit 550 can be designed or configured for sending and receiving RFID signals and processing data between the RFID circuit 550 and RFID tags 580 external to the UE device 120. RFID circuit 550 can include or utilize antennas, transceivers, and control units to facilitate communication with RFID tags 580 for identification, tracking, and data exchange using RFID technology deployed in various applications and for various purposes. RFID circuit 550 can be configured for any RF identification communication including UHF RF identification communication between 860 MHz and 960 MHz or microwave RFID operating at frequencies above 2.45 GHz. RFID circuit 550 can include and utilize functionalities or circuitry for creating, maintaining or facilitating the processed RF in the RFID operating frequency range.

Processing circuit 560 can include any processor or a controller for facilitating management and control of the cellular transceiver 502 and the RFID circuit 550. Processing circuit 560 can include an application processor or microcontroller for controlling and managing the operation of various components in the circuit in example 500. For instance, processing circuit 560 can process data, execute instructions, and interface with external devices to allow for the functionality of the overall system. Processing circuit 560 can control the switch circuit 530 to route or prioritize cellular signals over RFID signals. For example, processing circuit 560 can control the switch circuit 530 to route the signals from the cellular transceiver 502 whenever they are available, and routing signals from RFID circuits 550 only when signals from the transceiver 502 are not being generated. Similarly, processing circuit 560 can cause the RF communication chain circuitry to prioritize the incoming cellular signals over the incoming RF identification signals. The processing circuit 560 can coordinate with the cellular modem 505 to execute such operations or a portion of such operations. The processing circuit 560 and the cellular modem 505 can perform such operations individually or in combination, depending on the configuration.

RFID tag 580 can include any circuit or a device equipped with an antenna and a microchip to communicate responsive to transmissions of RF identification communication. RFID tag 580 can be configured to receive a transmission from the antenna 128 generated by the RFID circuit 550 and processed by at least a portion of the cellular RF communication chain, and responsive to this received communication power up its circuit and transmit a response signal to the antenna 128. RFID tag 580 can be configured for various identification and tracking purposes in different applications, including inventory management, access control, and asset tracking. RFID Tag 580 can store data that can be read wirelessly by an RFID reader device (e.g., RFID circuit 550), allowing for the identification of tagged items. When energized by RF signals emitted by the RFID reader, RFID tag 580 can transmit its stored data back to the reader, allowing seamless communication between the two devices. RFID tag 580 can be integrated in an external device or a system as an accessory of the UE device 120.

Base station 110 can include any base station or an access point configured to facilitate wireless communication, such as for example cellular communication provided by the antenna 128 of the UE 120. Base station 110 can be deployed within a signal range of the UE 120 and can transmit and receive cellular transmission from the UE 120, via antenna 128 that can also be utilized for communicating with one or more RFID tags 580.

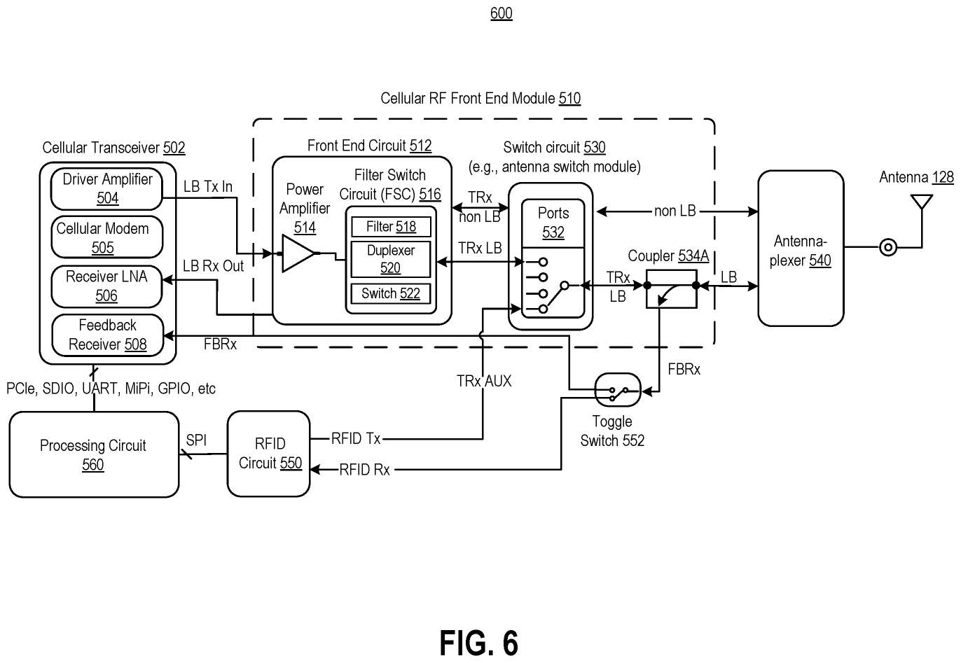

Referring now to FIG. 6, another example 600 of a circuit having the cellular communication chain integrated with RFID wireless communication, is illustrated. As with example 500, example circuit 600 can include a cellular RF communication chain integrated with an RFID circuit 550 via a switch circuit 550. However, in example 600, the integration utilizes a toggle switch 552 deployed between a coupler 534A and a RFID circuit 550 instead of a coupler 534B.

As shown in example 600, toggle switch 552 can have an input port that can be coupled with an output port of a coupler 534A providing a feedback signal for a feedback receiver 508 or a RF identification signal received via the antenna 128. Toggle switch 552 can have an output port for providing the RF identification signal, received via the coupler 534A, to the RFID circuit 550. Toggle switch 552 can have an output port for providing the feedback signal, received via the coupler 534A, to the feedback receiver 508. RFID transmission signals from the RFID circuit 550 can be coupled to an input port 532 of a switch circuit 530, thereby being fed to the switch circuit 530 directly from the RFID circuit 550.

Toggle switch 552 can include any switch that can alternate between two or more positions. Toggle switch can include any functionality of a switch circuit 530 or switch 522. Toggle switch 552 can be coupled to a RFID circuit 550, feedback receiver 508 and a coupler 534. Toggle switch 552 can to route signals between different pathways based on specific conditions or control signals. Toggle switch 552 can include an input port that can be connected to an output port of a coupler 534A, allowing it to receive either a feedback signal for a feedback receiver 508 or an RF identification signal received via the antenna 128. Toggle switch 552 can have output ports for directing signals accordingly: one output port provides the RF identification signal, received via coupler 534A, to the RFID circuit 550, while another output port delivers the feedback signal, also received via coupler 534A, to the feedback receiver 508.

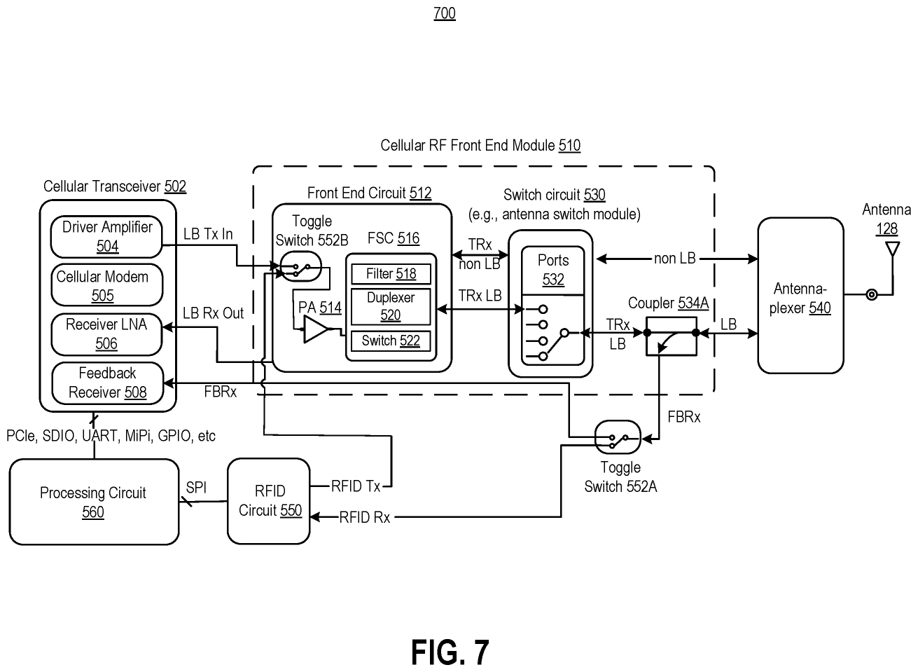

Referring now to FIG. 7, another example 700 of a circuit having the cellular communication chain integrated with RFID wireless communication, is illustrated. Similar as in example 600, example circuit 700 can include a cellular RF communication chain integrated with an RFID circuit 550 via a switch circuit 530 using a toggle switch 552A deployed between the coupler 534A and a RFID circuit 550. However, example circuit 700 can include a toggle switch 552B deployed before or within a front end circuit 512. Toggle switch 552B can be configured to receive as its inputs a low-band transmission signal generated by the driver amplifier 504 and a RF identification signal from the RFID circuit 550 and toggle between them to output one of those signals to the power amplifier 514 for amplification before additional processing by the FSC 516.

Toggle switch 552A can have an input port that can be coupled with an output port of a coupler 534A providing a feedback signal for a feedback receiver 508 or a RF identification signal received via the antenna 128. Toggle switch 552A can have an output port for providing the RF identification signal, received via the coupler 534A, to the RFID circuit 550. Toggle switch 552A can have an output port for providing the feedback signal, received via the coupler 534A, to the feedback receiver 508.

Toggle switch 552B can have two input ports, one for low-band transmission signal from the driver amplifier 504 and another one for RF identification transmission signal generated by the RFID circuit 550. Toggle switch 552B can include control circuitry with control signals for toggling between two inputs and providing those inputs to the power amplifier 514 for front end processing. Once coupled into the FSC 516, the low-band transmission signal generated by the driver amplifier 504 or the RF identification transmission signal generated by the RFID circuit 550 can be processed by the remainder of the cellular RF communication chain and be transmitted via the antenna 128.

Technical solutions of the present disclosure can relate to a wireless communication device, such as UE 120. The wireless communication device (e.g., UE 120) can include a front end circuit 512 configured to receive from a cellular transceiver 502, a first radio frequency (RF) signal as input. The front end circuit 512 can be configured to provide a processed first RF signal as output. The processed RF signal can be processed for a variety of desired features, including amplification (e.g., increase of signal power or amplitude), filtering or removal of undesired frequencies or frequency ranges from the signal, or for any other signal manipulation, routing or control. The processed first RF signal can include a signal for wireless communication via a cellular network. The input first signal and the processed first RF signal can be controlled by the cellular modem 505 and the network condition of the base station 110.

The wireless communication device (e.g., UE 120) can include an RF identifier circuit 550 (RFID circuit 550). RFID circuit 550 can generate a second RF signal, such as an RFID transmission signal. The second RFID signal can include a RF identification transmission signal destined to be transmitted, by the antenna 128, to an external RFID tag 580. The second RF signal can be a signal for wireless communication with the RF identifier tag 580.

The wireless communication device (e.g., UE 120) can include a switch circuit 530. The switch circuit 530 can be designed or configured to route the processed first RF signal (e.g., cellular communication signal) and the second RF signal (e.g., the RFID signal). For instance, the switch circuit 530 can include circuitry, such as one or more switches, ports, multiplexers or demultiplexer that can be arranged to cause the routing of the processed first RF signal for transmission via one or more antennas 128 for the wireless communication via the cellular network (e.g., BS 110). For instance, the switch circuit 530 can include circuitry, such as one or more switches, ports, multiplexers or demultiplexer that can be arranged to cause the routing of the second RF signal for transmission via the same one or more antennas 128 for the wireless communication with the RF identifier tag 580.

The wireless communication device (e.g., UE 120) can include an amplifier (e.g., driver amplifier 504) of the cellular transceiver 502 configured for wireless communication via one or more cellular networks (e.g., BS 110 configured for cellular network communication). The amplifier 514 can be configured to output the first RF signal. The front end circuit 512 can be comprised within, or be a part of, a cellular communication chain configured to provide a communication path for processing receive and transmission cellular communication of the UE 120.

The front end circuit 512 can include a power amplifier 514 to process the first RF signal and output an amplified first RF signal. The power amplifier can amplify or increase the power or strength of the first RF signal (e.g., low-band transmission signal generated by the cellular transceiver 502). The front end circuit 512 can include a filter switch circuit 530 that can be configured (e.g., arranged or connected) to receive the amplified first RF signal as input and output the processed first RF signal. The filter switch circuit 516 of the front end circuit 512 can include a filter 518 to suppress one or more frequencies of the amplified first RF signal. The filter switch circuit 516 of the front end circuit 512 can include a duplexer circuit (e.g., 520) configured to reduce an interference between the processed first RF signal to be transmitted via the antenna 128 and a third RF signal received via the antenna 128. The filter switch circuit 516 of the front end circuit 512 can include a switch 522 to route the processed first RF signal to the switch circuit 530.

The switch circuit 530 can include a plurality of ports 532. The plurality of ports 532 can include a first one or more ports 532 to route at least one of the first processed RF signal (e.g., received from the front end circuit 512) or the second RF signal (e.g., received from the RFID circuit 550, via a coupler 534). The switch circuit 530 can include a second port 532 of the plurality of ports to route one or more RF signals that do not satisfy the threshold for low-band frequencies (e.g., controlled by the cellular modem 505). For instance, the second port 532 can be used for routing non-low band signal.

The wireless communication device (e.g., UE 120) can include a coupler 534A that is communicatively coupled with the switch circuit 530. The coupler 534A can include a first port of the coupler to receive at least one of the processed first RF signal or the second RF signal. The coupler 534A can include a second port to route at least a portion of the at least one of the processed first RF signal or the second RF signal for transmission via the antenna 128.

The wireless communication device (e.g., UE 120) can include the second port of the coupler 534A that is configured to receive at least one of a third RF signal via the antenna 128 or a fourth RF signal for the wireless communication with the RF identifier tag 580. The third RF signal can be a signal transmitted by the BS 110 for cellular communication of the UE 120. The third RF signal can be received via the antenna 128 and destined for the cellular transceiver 502. The fourth RF signal can be a signal transmitted by the RF tag 580, received by the antenna 128 and destined for the RFID circuit 550 to decode and process the fourth RF signal. The first port of the coupler 534A can be configured to transmit to the switch circuit 530 the at least one of the third RF signal or the fourth RF signal.

The wireless communication device (e.g., UE 120) can include the coupler 534A having a third port of the coupler 534A configured to transmit to a feedback receiver 508 of the cellular transceiver 502, at least a second portion of the at least one of the processed first RF signal or a third RF signal received via the antenna. For example, the third port can be configured to receive a portion of the processed first RF signal (e.g., set for transmission via the antenna 128) or a portion of the third RF signal (e.g., received by the antenna 128 from a remote BS 110 configured for cellular configuration).

The wireless communication device (e.g., UE 120) can include a toggle switch 552A that can include an input port to receive, from a third port of the coupler 534A, at least one of a portion of the second RF signal or a portion of a fourth RF signal for the wireless communication with the RF identifier tag 580. The toggle switch 552 can include an output port configured to transmit to the RF identifier circuit 550 at least one of the portion of the second RF signal or the portion of the fourth RF signal. The toggle switch 552A can include an output port configured to transmit to a feedback receiver 508, of the cellular transceiver 502, at least one of the portion of the first processed RF signal or the portion of the third RF signal.

The wireless communication device (e.g., UE 120) can include a switch 552B of the front end circuit 512. The switch 552B can include a first input to receive the first RF signal. The switch 552B can include a second input to receive the second RF signal. The switch 552B can include an output to provide at least one of the first RF signal or the second RF signal to a power amplifier of the front end circuit 512.

The wireless communication device (e.g., UE 120) can include a coupler 534B between the RF identifier circuit 550 and the switch circuit 530. The coupler 534B comprising a plurality of ports 532. The plurality of ports 532 can include a first port 532 to receive the second RF signal from the RF identifier circuit 550. The coupler 534B can include a second port to provide the second RF signal to the switch circuit 530 and receive a fourth RF signal via the antenna 128. The coupler 534B can include a third port 532 to transmit at least a portion of at least one of the second RF signal or the fourth RF signal to the RF identifier circuit 550.

In some aspects, the technical solutions are directed to a cellular communication chain. The cellular communication chain can include a plurality of circuits or circuit elements configured or arranged for processing cellular communication transmissions. The cellular communication chain can include a front end circuit 512 of the cellular communication chain. The front end circuit 512 can be configured to receive, from a cellular transceiver 502, a first radio frequency (RF) signal as input and provide a processed first RF signal as output. The processed first RF signal can be for wireless communication via a cellular network (e.g., with a BS 110).

The cellular communication chain can include a switch circuit configured to receive from an RF identifier circuit a second RF signal. The second RF signal can be for wireless communication with an RF identifier tag and can satisfy the threshold for low-band frequencies in the range of the low-band frequencies of the signals generated by the cellular modem 505. The switch circuit 530 can be configured to route the processed first RF signal for transmission via an antenna for the wireless communication via the cellular network. The switch circuit 530 can be configured to route the second RF signal for transmission via the antenna for the wireless communication with the RF identifier tag 580.

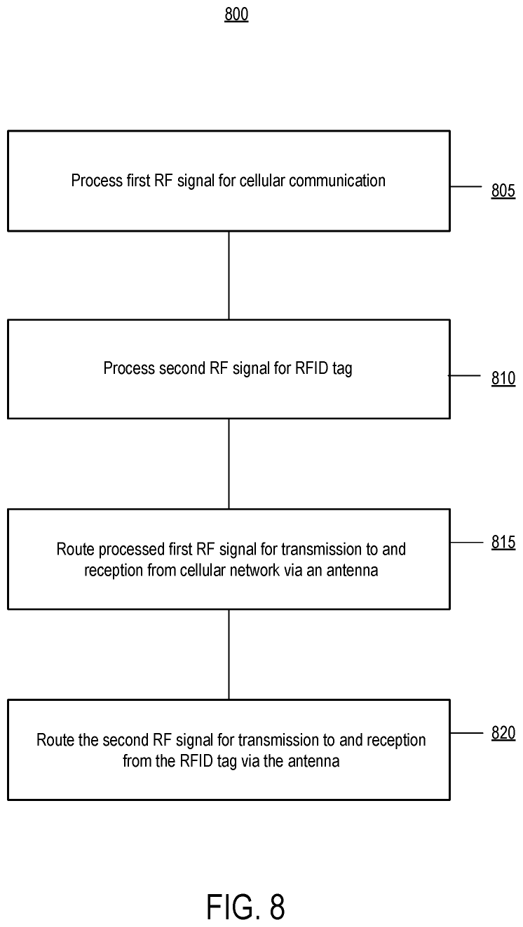

Turning now to FIG. 8, an example flow diagram of a method 800 for using a cellular communication chain integrated with RFID wireless communication to communicate with an external RFID tag and a base station that is configured for cellular network communication. The method 800 can be performed by a system having one or more processors configured to perform operations of the system features and examples discussed in connection with FIGS. 1-7. The method can be implemented using a non-transitory computer readable medium storing instructions which, when executed by one or more processors, cause the one or more processors to implement operations of the method 800.

The method 800 can include operations 805-820. At operation 805, the method can include processing of a first RF signal for cellular communication. At operation 810, the method can include generating a second RF signal for an RFID tag. At operation 815, the method can include routing the processed first RF signal for transmission to a cellular network via an antenna. At operation 820, the method can include routing the second RF signal for transmission to the RFID tag via the antenna.

At operation 805, the method can include processing of a first RF signal for cellular communication. The method can include a front end circuit receiving a first radio frequency (RF) signal as input from a transceiver. The method can include the front end circuit providing a processed first RF signal as output. The processed first RF signal can be a signal, or a transmission generated for wireless communication via a cellular network. The processed first RF signal can satisfy a threshold for low-band frequencies. For instance, the processed first RF signal can be filtered by a low pass filter to remove the frequencies above a low-band threshold. The processed first RF signal can include a low-band transmission signal generated by a driver amplifier of the cellular transceiver for processing and subsequent transmission via the antenna to a base station configured for wireless cellular network communication.

The front end circuit can be comprised in a cellular communication chain or a cellular RF communication chain. For example, the front end circuit can include a front end circuit of a cellular RF communication channel that can include a series of circuitry components. The circuitry components can include a cellular transceiver, a cellular RF front end module and an antenna-plexer coupled with an antenna configured for cellular network communication. The cellular RF front end module can include the front end circuit communicatively coupled with a cellular transceiver generating the first RF signal and a switch circuit communicatively coupled with the front end circuit to route the processed first RF signal.

The method can include a power amplifier processing the first RF signal to output an amplified first RF signal. The power amplifier can be a power amplifier of the front end circuit. The power amplifier can be communicatively coupled with a filter switch circuit. The method can include the filter switch circuit receiving the amplified first RF signal as input to output the processed first RF signal. The filter switch circuit can include a filter to suppress one or more frequencies of the amplified first RF signal. The filter can be a low pass filter, a high pass filter, a band pass filter or any other filter configured to suppress, attenuate or filter out portions of a signal of a certain frequency range. The filter switch circuit can include a duplexer circuit configured to reduce an interference between the processed first RF signal to be transmitted via the antenna and a third RF signal received via the antenna. The filter switch circuit can include a switch to route the processed first RF signal to the switch circuit. The switch can be a switch configured to route or enable transmission or progress of the signal along the cellular RF communication chain.

At operation 810, the method can include processing a second RF signal for an RFID tag. For instance, the method can include generating a second RF signal for an RFID tag. The method can include an RF identifier circuit (e.g., RFID circuit) generating and processing the second RF signal for wireless communication with an RFID tag. The second RF signal can include a signal configured for RFID communication, such as a UHF RFID signal or a microwave RFID signal. The second RF signal can be configured to be transmitted by the antenna of the UE device to power up a remote RFID tag to produce and send a response, which the RFID circuit can decode and process. The second RF signal can be a signal for wireless communication with an RF identifier tag. The second RF signal can satisfy the threshold for low-band frequencies. For instance, the second RF signal can be filtered by a low pass filter configured to attenuate, suppress or remove frequencies above a low-band threshold.

The method can include an amplifier of the transceiver configured for wireless communication via one or more cellular networks. The method can include the amplifier of the transceiver outputting the first RF signal. The first RF signal can be amplified or processed by the amplifier of the transceiver to bring the signal strength to a level or range suitable for processing by the front end circuit. The first RF signal can be input into a power amplifier of the front end circuit to process the first RF signal.

At operation 815, the method can include routing the processed first RF signal for transmission to and reception from a cellular network, via an antenna. The method can include a switch circuit of a cellular RF front end module routing the processed first RF signal for transmission. The switch circuit can route the processed first RF signal for transmission via an antenna for the wireless communication via the cellular network. The method can include the switch circuit routing to the frond end circuit one or more RF signals from the external cellular network, received via the antenna. The switch circuit can route the processed first RF signal for processing via other components of the cellular RF communication chain. The switch circuit can route the processed first RF signal toward a coupler that can be configured to forward the signal to an antenna-plexer that can forward the processed first RF signal to the antenna.

The method can include a first port of a coupler communicatively coupled with the switch circuit receiving at least one of the processed first RF signal or the second RF signal. For example, the first port of the coupler can receive the processed first RF signal from the front end circuit. For example, the first port of the coupler can receive the second RF signal from the RFID circuit, via an intervening coupler or a switch. The method can include routing, by a second port of the coupler, at least a portion of the at least one of the processed first RF signal or the second RF signal for transmission via the antenna.

The method can include a coupler communicatively coupled with the switch circuit receiving one or more RF signals. For example, the coupler can receive, via the second port of the coupler, at least one of a third RF signal via the antenna or a fourth RF signal for the wireless communication with the RF identifier tag. For example, the coupler can transmit, via the first port of the coupler, to the switch circuit, the at least one of the third RF signal or the fourth RF signal. The coupler can forward signals received by the antenna to the switch circuit and can forward the signals from the switch circuit to the antenna, via the antenna-plexer.

At operation 820, the method can include routing the second RF signal for transmission to and reception from the RFID tag, via the antenna. The method can include the switch circuit routing the second RF signal for transmission via the antenna for the wireless communication with the RF identifier tag. The method can include the switch circuit routing to the RFID circuit one or more RF signals generated by the external RFID tag and received via the antenna. For example, the switch circuit can receive the second RF signal from a coupler disposed between the switch circuit and the RFID circuit, and can forward the second RF circuit, via one or more ports of the switch circuit, to an intervening coupler disposed between the switch circuit and the antenna-plexer coupled with the antenna.

The method can include prioritizing transmissions of the cellular signals (e.g., at operation 815) over transmissions of RF identification signals (e.g., at operation 820). For instance, the method can include a processor circuit along with the cellular modem controlling the RF communication chain circuitry to prioritize the first RF signal and the processed first RF signal over transmission of the second RF signal (e.g., from the RFID circuit). For instance, the method can include controlling the switch circuit to route the incoming or outgoing cellular communication signals (e.g., first RF signal and the processed first RF signal) through the RF communication chain circuitry whenever the cellular signals are present. The method can route the RF identification (e.g., the second RF signal) in response to detecting that no cellular communication is being transmitted or received.

The method can include the switch circuit routing, via a first one or more ports of a plurality of ports of the switch circuit, at least one of the first processed RF signal or the second RF signal. The routing can include directing the first processed RF signal or the second RF signal towards a portion of the cellular RF communication chain of the antenna, including the antenna-plexer and the antenna. The method can include the switch circuit routing, by a second one or more ports of the plurality of ports of the switch circuit, one or more RF signals that do not satisfy the threshold for low-band frequencies. For example, one or more signals having frequencies above the low-band threshold can be communicated by the switch circuit toward the antenna-plexer and for transmission via the antenna.

The method can include the coupler disposed between the switch circuit and the antenna-plexer transmitting, to a feedback receiver of the cellular transceiver, at least a second portion of the at least one of the processed first RF signal or a third RF signal (e.g., cellular signal) that is received via the antenna. The method can include a toggle switch disposed between a coupler and an RFID circuit transmitting, to a feedback receiver of the cellular transceiver, at least a second portion of the at least one of the processed first RF signal or a third RF signal (e.g., cellular signal) that is received via the antenna. The method can include transmitting, via a third port of the coupler, to a feedback receiver of the transceiver, at least a second portion of the at least one of the processed first RF signal or a third RF signal received via the antenna.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

We claim:

1. A wireless communication device, comprising:
a front end circuit configured to receive, from a transceiver, a first radio frequency (RF) signal as input, and provide a processed first RF signal as output, wherein the processed first RF signal is for wireless communication via a cellular network;
an RF identifier circuit to generate a second RF signal, wherein the second RF signal is for wireless communication with an RF identifier tag; and
a switch circuit configured to:
route the processed first RF signal for transmission via an antenna for the wireless communication via the cellular network; and
route the second RF signal for transmission via the antenna for the wireless communication with the RF identifier tag.

2. The wireless communication device of claim 1, comprising:
an amplifier of the transceiver configured for wireless communication via one or more cellular networks, the amplifier configured to output the first RF signal.

3. The wireless communication device of claim 1, wherein the front end circuit is comprised in a cellular communication chain, the front end circuit comprises:
a power amplifier to process the first RF signal and output an amplified first RF signal; and
a filter switch circuit to receive the amplified first RF signal as input and output the processed first RF signal.

4. The wireless communication device of claim 3, wherein the filter switch circuit of the front end circuit includes at least one of:
a filter to suppress one or more frequencies of the amplified first RF signal;
a duplexer circuit configured to reduce an interference between the processed first RF signal to be transmitted via the antenna and a third RF signal received via the antenna; or
a switch to route the processed first RF signal to the switch circuit.

5. The wireless communication device of claim 1, comprising:
a plurality of ports of the switch circuit, the plurality of ports including a first one or more ports to route at least one of the first processed RF signal or the second RF signal that are configured for the wireless communication via a low-band of the cellular network; and
a second one or more ports of the plurality of ports of the switch circuit to route one or more RF signals in a frequency range other than that of the low-band of the cellular network.

6. The wireless communication device of claim 1, comprising:
a coupler communicatively coupled with the switch circuit, comprising:
a first port to receive at least one of the processed first RF signal or the second RF signal; and
a second port to route at least a portion of the at least one of the processed first RF signal or the second RF signal for transmission via the antenna.

7. The wireless communication device of claim 6, wherein:
the second port of the coupler is configured to receive at least one of a third RF signal via the antenna or a fourth RF signal for the wireless communication with the RF identifier tag; and
the first port of the coupler is configured to transmit to the switch circuit the at least one of the third RF signal or the fourth RF signal.

8. The wireless communication device of claim 6, wherein the coupler comprises a third port of the coupler to transmit, to a feedback receiver of the transceiver, at least a second portion of the at least one of the processed first RF signal or a third RF signal received via the antenna.

9. The wireless communication device of claim 8, comprising:
a toggle switch comprising:
an input port to receive, from a third port of the coupler, at least one of a portion of the second RF signal or a portion of a fourth RF signal for the wireless communication with the RF identifier tag; and
an output port configured to transmit to the RF identifier circuit at least one of the portion of the second RF signal or the portion of the fourth RF signal.

10. The wireless communication device of claim 7, comprising:
a toggle switch comprising:
an output port configured to transmit to a feedback receiver of the transceiver at least one of the portion of the first processed RF signal or the portion of the third RF signal.

11. The wireless communication device of claim 1, comprising:
a switch of the front end circuit, the switch comprising:
a first input to receive the first RF signal;
a second input to receive the second RF signal; and
an output to provide at least one of the first RF signal or the second RF signal to a power amplifier of the front end circuit.

12. The wireless communication device of claim 1, comprising:
a coupler between the RF identifier circuit and the switch circuit, the coupler comprising a plurality of ports, the plurality of ports comprising:
a first port to receive the second RF signal from the RF identifier circuit;
a second port to provide the second RF signal to the switch circuit and receive a fourth RF signal via the antenna; and
a third port to transmit at least a portion of at least one of the second RF signal or the fourth RF signal to the RF identifier circuit.

13. A method, comprising:
receiving, by a front end circuit configured, from a transceiver, a first radio frequency (RF) signal as input to provide a processed first RF signal as output, wherein the processed first RF signal is for wireless communication via a cellular network
generating, by an RF identifier circuit, a second RF signal, wherein the second RF signal is for wireless communication with an RF identifier tag; and
routing, by a switch circuit, the processed first RF signal for transmission via an antenna for the wireless communication via the cellular network; and
routing, by the switch circuit, the second RF signal for transmission via the antenna for the wireless communication with the RF identifier tag.

14. The method of claim 13, comprising:
an amplifier of the transceiver configured for wireless communication via one or more cellular networks, the amplifier configured to output the first RF signal.

15. The method of claim 13, wherein the front end circuit is comprised in a cellular communication chain, the method comprising:
processing, by a power amplifier, the first RF signal to output an amplified first RF signal; and
receiving, by a filter switch circuit, the amplified first RF signal as input to output the processed first RF signal, wherein the filter switch circuit includes at least one of: a filter to suppress one or more frequencies of the amplified first RF signal, a duplexer circuit configured to reduce an interference between the processed first RF signal to be transmitted via the antenna and a third RF signal received via the antenna, or a switch to route the processed first RF signal to the switch circuit.

16. The method of claim 13, comprising:
routing, by a first one or more ports of a plurality of ports of the switch circuit, at least one of the first processed RF signal or the second RF signal that are configured for the wireless communication via a low-band of the cellular network; and
routing, by a second one or more ports of the plurality of ports of the switch circuit, route one or more RF signals in a frequency range other than that of the low-band of the cellular network.

17. The method of claim 13, comprising:
a coupler communicatively coupled with the switch circuit, comprising:
receiving, by a first port of a coupler communicatively coupled with the switch circuit, at least one of the processed first RF signal or the second RF signal; and
routing, by a second port of the coupler, at least a portion of the at least one of the processed first RF signal or the second RF signal for transmission via the antenna.

18. The method of claim 17, comprising:
receiving, by the second port of the coupler, at least one of a third RF signal via the antenna or a fourth RF signal for the wireless communication with the RF identifier tag; and
transmitting, by the first port of the coupler, to the switch circuit, the at least one of the third RF signal or the fourth RF signal.

19. The method of claim 17, wherein the coupler comprises a third port to transmit, to a feedback receiver of the transceiver, at least a second portion of the at least one of the processed first RF signal or a third RF signal received via the antenna.

20. A cellular communication chain, comprising:
a front end circuit of the cellular communication chain configured to receive, from a transceiver, a first radio frequency (RF) signal as input and provide a processed first RF signal as output, wherein the processed first RF signal is for wireless communication via a cellular network; and
a switch circuit configured to:
receive from an RF identifier circuit a second RF signal, wherein the second RF signal is for wireless communication with an RF identifier tag;
route the processed first RF signal for transmission via an antenna for the wireless communication via the cellular network; and
route the second RF signal for transmission via the antenna for the wireless communication with the RF identifier tag.
